(19) United States
(12) Patent Application Publication
(10) Pub. No.: US 2024/0116586 A1
(43) Pub. Date: Apr. 11, 2024

(54) METHOD FOR ASSEMBLING A MOTOR VEHICLE BODY

(71) Applicant: Volkswagen Aktiengesellschaft, Wolfsburg (DE)

(72) Inventors: Christian SCHWERING, Gross Hesepe (DE); Thomas PAULSEN, Wolfsburg (DE); Werner KRAUTH, Wolfsburg (DE)

(73) Assignee: Volkswagen Aktiengesellschaft, Wolfsburg (DE)

(21) Appl. No.: 18/542,740

(22) Filed: Dec. 17, 2023

Related U.S. Application Data
(63) Continuation of application No. PCT/EP2022/061671, filed on May 2, 2022.

(30) Foreign Application Priority Data
Jun. 22, 2021 (DE) 10 2021 206 369.1

(51) Int. Cl. B62D 65/04

(52) U.S. Cl. CPC B62D 65/04; B62D 25/08

(57) ABSTRACT

A method for assembling a motor vehicle body, wherein the motor vehicle body has a front end structure with a bulkhead and a body area arranged in the longitudinal direction of the motor vehicle behind the bulkhead. The front end structure is pre-assembled separate from the body area before connecting the front end structure to the body area located behind the bulkhead. The separation between the pre-assembled front end structure and the body area is immediately in front of or behind the bulkhead.

This nonprovisional application is a continuation of International Application No. PCT/EP2022/061671, which was filed on May 2, 2022, and which claims priority to German Patent Application No. 10 2021 206 369.1, which was filed in Germany on Jun. 22, 2021, and which are both herein incorporated by reference.

### BACKGROUND OF THE INVENTION

### Field of the Invention

The invention relates to a method for assembling a motor vehicle body.

### Description of the Background Art

Motor vehicle bodies such as those at issue have a front end structure with a bulkhead and a body area arranged in the longitudinal direction of the motor vehicle behind the bulkhead.

The bulkhead of the vehicle body is a two-dimensional structure that forms a separation between the passenger compartment and the front end of the motor vehicle. Historically, such bulkheads have also been referred to as “firewalls” because they were used in earlier motor vehicles to protect passengers from a fire in the engine compartment.

In addition, such fire walls can also be used to absorb forces in the event of a frontal collision of the motor vehicle with an obstacle and to transmit them to the surrounding structures of the motor vehicle body. In this way, the fire walls can help protect the occupants from mechanical impacts in the event of accidents.

In modern motor vehicles, the body area behind the bulkhead is in particular the passenger compartment. In modern motor vehicles, this forms the largest part of the vehicle body. Typically, in the direction of travel, the passenger compartment is structurally divided into two longitudinal beams, which extend longitudinally in the front end arranged in front of the vehicle body. The bulkhead often consists of a plurality of elements which are arranged around the longitudinal beams at the boundary between the front end structure and the body area arranged in the longitudinal direction of the vehicle behind the bulkhead and are typically welded. From a structural point of view, especially with regard to the transmission of forces, the body area located behind the bulkhead forms a unit with the longitudinal beams extending through the front end.

Although this makes sense from a mechanical point of view, in particular with regard to the load paths in the event of a frontal collision, it means that for the assembly of the vehicle body, the body front end is built while the front end is connected to the body area located behind the bulkhead. The assembly is correspondingly complex, in particular the entire—or at least almost the entire—vehicle body has to be handled while work is carried out on the front end.

Therefore, approaches are already known from the state of the art to simplify the assembly of the front end structure. For example, a load-bearing structural component is known from DE 10 2011 119 561 A1, which corresponds to US 2013/0134742, and which has at least one strut mount and a bulkhead section. The load-bearing structural component is designed as a casting. By means of such a load-bearing structural component, a part of the front end structure, which already has a comparatively high level of complexity, can be prefabricated in one piece and then connected to the front end structure in one piece. Although this reduces the production steps that have to be carried out on the front end structure as part of the overall body, the installation of the load-bearing structural component into the front end structure must still be carried out, while the front end structure is already a component of the rest of the vehicle body.

DE 10 2004 035 530 B4 also discloses a method in which a part of the front end structure is attached to the body of the motor vehicle. Although the pre-assembled section of the front end is larger in this solution than in the case of the state of the art cited above, large areas of the front end structure are still part of the pre-assembled front end structure. This includes, in particular, the bulkhead, which continues to be conventionally attached to the body area behind the bulkhead, becoming fragmented from a large number of individual parts before the prefabricated part of the front end structure is connected to the rest of the vehicle body.

### SUMMARY OF THE INVENTION

It is therefore an object of the invention to provide a method for assembling a motor vehicle body, which simplifies the production of the motor vehicle body in the area of the front end.

The method involves pre-assembling the front end structure separately from the body area before connecting the front end structure to the body area behind the bulkhead. The separation between the pre-assembled front end structure and the body area runs directly in front of or behind the bulkhead.

In other words, the separation between the front end structure to be prefabricated and the rest of the vehicle body is moved behind the bulkhead. In this way, it will be possible to carry out the pre-assembly of the front end structure, up to and/or including the bulkhead, independently of the rest of the vehicle body. In addition, the separation directly in front of or behind the bulkhead makes it possible to use large-area components to produce the bulkhead, in the best case the entire bulkhead can be designed in this way in one piece.

The method may provide connecting the bulkhead to the pre-assembled front end structure before connecting the front end structure to the body area located behind the bulkhead. The bulkhead thus becomes part of the pre-assembled front end structure and, in particular, forms its rear closure in the longitudinal direction of the vehicle.

Alternatively, the method may provide connecting the bulkhead to the body area located behind the bulkhead before connecting the front end structure to the body area located behind the bulkhead. In this case, up to the time when the pre-assembled front end structure is connected to the body, the bulkhead forms in particular the end of the vehicle body pointing in the longitudinal direction of the vehicle.

The method may provide for longitudinal beams of the front end structure to be connected to the bulkhead during the pre-assembly of the front end structure. In this way, it is possible for mechanical forces acting on the longitudinal beams to be transmitted via the bulkhead to the body area located behind the bulkhead. This is particularly advantageous in the context of the edges of the bulkhead, which at least extend essentially in the transverse direction of the vehicle and are arranged in front of body structures, in particular in front of components of the A-pillars of the motor vehicle body. In this way, forces that are introduced into the bulkhead can be advantageously transferred to the body behind the bulkhead over the edge areas. In this way, the bulkhead can perform a “protective shield-like” function in the event of a frontal collision.

The longitudinal beams can be connected to the bulkhead in particular by means of connecting elements. The connecting elements can be connected to the longitudinal beams as well as to the bulkhead.

In particular, the use of such connecting elements makes it possible to use different combinations of materials. For example, the longitudinal beams can be designed as large cast components, especially made of die-cast aluminum, or steel or aluminum sheets, non-metallic materials or a mixed construction concept can also be used. The bulkhead and the connecting elements are mainly made of steel. In particular, the steel can be heat-treated to increase its strength. Such steels are characterized by high strength and at the same time good ductility. In addition, the connecting elements can be advantageously connected to the bulkhead by means of a welded joint if both components are made of steel. Preferably, the longitudinal beams are first connected to the connecting elements before they are connected to the bulkhead. In this way, the connection of the longitudinal beams to the bulkhead can be made in an advantageous manner, particularly if the longitudinal beams are made of a material different from the material of the connecting elements and the bulkhead, so that, for example, when connecting the longitudinal beams to the connecting elements, an adhesive process can be used first before the connecting elements are welded to the bulkhead. In particular, if both the longitudinal beams and the bulkhead are made of steel, the longitudinal beams can be directly connected to the bulkhead, in particular by welding.

In particular, the connecting elements can be designed in such a way that one of their sections lies flat against the bulkhead. As a result, the weld joints can be realized advantageously, for example by means of welding points. Furthermore, the connecting elements can be advantageously designed in such a way that they enclose a section of the longitudinal beams in a sleeve-like manner. In this case, the connecting elements can enclose all and/or part of the circumference of the longitudinal beams. The connecting elements can also lie flat against the longitudinal beams. This is advantageous, for example, for the formation of a material connection between the longitudinal beam and the connecting element, such as an adhesive connection. Alternatively and/or in addition, other joining techniques, in particular from the field of mixed construction, can be used, such as screw connections, in particular by means of flow hole screws, rivet connections, in particular by means of semi-tubular self-pierce rivets and/or solid self-pierce rivets, and/or other material-locking processes, in particular friction welding and/or resistance welding.

The method may provide for structural elements to connect the longitudinal beams to the body area behind the bulkhead during pre-assembly. For this purpose, such structural elements can be guided in particular through openings in the bulkhead. The structural elements are able to create a mechanical connection between the longitudinal beams and the body area located behind the bulkhead, thereby transmitting mechanical forces from the longitudinal beams to the body area located behind the bulkhead.

In particular, the method may provide for the longitudinal beams to be designed as a hollow structure and for the structural elements to be connected to the inner side of the hollow structure. In this case, in particular, a part of the respective longitudinal beam can only be attached to the longitudinal beam after the corresponding structural element has been connected to the inner side of the longitudinal beam. As a result, the “inner space” of the longitudinal beam remains accessible in order to connect the structural element to the inner side of the hollow structure.

The structural elements can first be connected to the bulkhead before the longitudinal beams are connected to the bulkhead and/or the structural elements to the longitudinal beams. This makes it possible to create a unit consisting of bulkhead and structural elements, which can be connected to the longitudinal beams in an advantageous manner. The connection of the unit consisting of structural elements and bulkhead to the longitudinal beams can be carried out in particular by means of the connecting elements described above, which are preferably already connected to the longitudinal beams.

The structural elements can be passed through openings in the bulkhead, especially before they are connected to the bulkhead and/or the longitudinal beams. Guiding the structural elements through the openings allows for a load path bridging the bulkhead, by means of which forces can be introduced from the longitudinal beams over the structural elements into the body area located behind the bulkhead.

The method may provide for structural components to be connected to the longitudinal beams. The structural components initially comprise part of a strut dome, an upper longitudinal beam and/or a wheel arch. In particular, the structural components can be connected to the longitudinal beams before the longitudinal beams are connected to the structural elements and/or the bulkhead. This forms a unit consisting of the longitudinal beams and the structural components, which in turn can be advantageously handled as a whole and connected to the bulkhead and/or structural elements, in particular a unit formed by the structural elements and the bulkhead.

The method may provide for a cowl crossmember to be connected to the bulkhead and/or structural components before connecting the front end structure to the body area located behind the bulkhead. Such a cowl crossmember can thus also become part of the pre-assembled front end structure.

When connecting cowl crossmembers and/or structural components to the bulkhead, connecting elements can also be used to connect the respective components to the bulkhead, as described above for the longitudinal beams. These connecting elements and their processing in the course of the method may have the same features as the connecting elements described above in connection with the connection of the longitudinal beams to the bulkhead.

The method may provide for a component forming at least the part of the bulkhead that is connected to the longitudinal beams to be manufactured from a two-dimensional semi-finished product by means of a forming process. As a result, a comparatively large area of the bulkhead, in particular the entire bulkhead, is provided as a one-piece component by means of a forming process. It has been shown that such a component can be provided as a component of the bulkhead or as a bulkhead in an advantageous manner. In the context of the vehicle body manufacturing process described above, such large-area one-piece components are particularly advantageous as part of the bulkhead or as the bulkhead, since they can be easily processed in the sequence of joining the individual components of the front end structure to each other in spite of their large surface area, as described above.

In particular, the forming process can be direct or indirect hot forming. In the case of direct hot forming, the forming takes place after the semi-finished product has been heated to an increased temperature, which is particularly above the recrystallization temperature of the respective material. In the case of indirect hot forming, cold forming is carried out before the semi-finished product is heated. After cold forming, the semi-finished product is heated and hot-formed. In this case, the degree of forming of hot forming can be comparatively low as compared to that of cold forming. Both hot forming processes can provide for heat treatment to increase strength in the context of hot forming. This means, in particular, that the heat treatment takes place while the semi-finished product that has already been hot-formed is still in the mold for hot forming.

In particular, before the forming is carried out, the semi-finished product can be made from a large number of, in particular flat, sheets which are joined together in the area of their edges. Such semi-finished products are also referred to as so-called tailor-welded blanks. In particular, the edges of the individual sheets can be welded. However, it is also possible to connect the edges together in an overlapping way. In this case, point welding methods can also be used. The use of other joining methods is also possible.

Alternatively and/or in addition, the semi-finished product may, before and/or during forming, be manufactured by means of materially connecting at least one, in particular planar, reinforcing plate applied to an, in particular, flat metal sheet and/or to a plurality of plates connected in the area of their edges with the metal sheet and/or the connected sheets. Such reinforcing plates are also known as patch reinforcements. These can be connected to the base plate by means of spot welding, laser welding and/or projection welding. In this case, the welding process is preferably carried out before forming. Alternatively and/or in addition, warm clinching, especially during forming, and/or the use of a soldering process to connect the reinforcing plates to the base plate is possible. A soldering process can be carried out, for example, by using a solder foil inserted between the reinforcing plate and the metal sheet and/or the connected sheets.

In other words, it is possible for the semi-finished product to be formed by applying one or more reinforcing plates as patch reinforcements to a one-piece sheet. It is also possible to first manufacture a tailor-welded blank, to which further reinforcing plates are then applied as patch reinforcements. A major advantage in the manufacturing of semi-finished products in the way described above is that it can be done by processing flat sheets. This considerably simplifies the process management in the manufacturing of the semi-finished product for forming. This applies in particular to the preferred material connection of the sheets to each other and/or of the sheets and reinforcing plates by means of welding processes.

In particular, the material connection of the sheets to each other and/or to at least one reinforcing plate can be carried out by laser beam welding. The preferred manufacturing of the semi-finished product by laser beam welding can be carried out in particular by laser remote welding. In remote laser welding or scanner welding, the positioning of the laser beam is carried out by and/or with the help of movable deflection mirrors. This makes it possible to achieve an efficient and highly automated production of semi-finished products for hot forming. In particular, laser remote welding can also be used to process large-area workpieces quickly, as the laser can act on the workpiece from a comparably large distance. The flat shape of the semi-finished products in the form of planar sheets, that is to say, in particular, flat and non-formed sheets, has a positive effect on the possibility of using the laser scanners in question to carry out the welding process.

In particular, the metal sheets and/or reinforcing plates may be sheets with different properties. In this way, bulkheads can be manufactured in which individual areas of the bulkhead can have different properties. In this way, the bulkhead can be specifically adapted to the requirements, especially the mechanical requirements placed on its individual areas. In particular, the behavior of individual areas of the bulkhead can be specifically influenced in the event of a deformation, for example in the event of a crash.

The different properties can be in particular different strengths and/or ductility. Different strengths can be understood as the tensile strength of the material, especially the steel used, in the finished workpiece. In this way, for example, zones with higher or lower strength and/or ductility can be realized in a targeted manner, which is particularly advantageous with regard to the adaptation of the bulkhead to the desired properties in the event of a crash. In particular, the ductility in the individual areas of the bulkhead can be adjusted differently in order to enable high degrees of deformation and thus a corresponding energy dissipation in the context of deformation in areas with higher ductility and lower strength, while in other areas the degree of deformation is correspondingly limited by their higher strength and lower ductility. Alternatively and/or in addition, the sheets and/or reinforcing plates used may have different thicknesses. By using different thicknesses, the strength of different areas of the bulkhead can also be specifically influenced. Alternatively and/or in addition, the use of different types of steel can also be considered in order to specifically influence the properties of different areas of the bulkhead.

Before and/or during forming, at least one section of the metal sheet and/or at least one of the connected sheets can be cut out. In particular, this makes it possible to create openings in the bulkhead. It is also possible to cut out a section of the edge of the metal sheet or the connected sheets. In this way, the edge contour of the bulkhead resulting in the course of forming can be specifically influenced in order to simplify or, in particular, completely replace any trimming of the edges that may be necessary after forming.

The cutting out of at least one section can be carried out mechanically before and/or during forming. In particular, the forming tool may have appropriate cutting edges through which the cutting is carried out during forming. Alternatively and/or additionally, the cutting out can be carried out by means of a laser. Here, too, laser remote cutting can be used in particular. Similar to laser welding described above, the flat shape of the semi-finished product has a particularly advantageous effect on processing time for laser remote cutting, but also for mechanical cutting.

In particular, openings may be provided in the semi-finished product which form openings in the bulkhead after the forming has been carried out. This can be done by cutting out at least one section, as described above. Alternatively and/or in addition, it is also possible, for example if the semi-finished product is a tailor welded blank, to provide the openings by omitting at least a section of the semi-finished product when producing the semi-finished product from a plurality of sheets. This has the advantage that the corresponding openings can be created without having to cut out material areas afterwards, which reduces the processing effort and can also lead to material savings.

In particular, the openings in the bulkhead formed in this way may be openings that serve to pass through the structural elements. In this way, it is possible to connect the structural elements in an advantageous way to the body area behind the bulkhead and the longitudinal beams in a cost-effective manner.

In particular, after forming, the edge areas of the component can be cut to a desired contour. This makes it possible to produce very custom-fit bulkheads. The cutting of the edge areas is also advantageously carried out by means of laser cutting, in particular laser remote cutting. The forming process described above is particularly advantageous for the production of large-area bulkheads with a comparatively flat structure. Bulkheads shaped in this way are particularly suitable for cutting the edge areas by means of laser cutting, especially laser remote cutting.

Alternatively and/or additionally, the edges of the semi-finished product can be cut to size before and/or during forming. In this case, mechanical cutting processes can also be used. In particular, cutting to size can be carried out by means of appropriate cutting edges in the forming tool. In this case, the edge area of the semi-finished product is cut to size in such a way that the desired contour of the edge area of the component is obtained due to the forming. In this way, the post-processing of the edge areas after the forming process can be reduced by cutting the edge area of the semi-finished product to a suitable contour before the forming process is carried out. It has been shown that the contour of the formed component can be specified in this way with sufficient accuracy to avoid or at least significantly reduce reworking of the contour of the edge area after forming, thus significantly reducing costs. For example, the width of the bulkhead can be specified with sufficient accuracy, for example a tolerance of +/−3 mm, and trimming, which is preferably done by laser if the bulkhead is highly resistant, can ideally be avoided.

In particular, the method may provide for the manufacture of vehicle bodies for a number of different types of motor vehicles. In this process, components are manufactured for different types of motor vehicles that form at least part of the bulkhead that extends over the edge area of the bulkhead. In particular, an edge area of a semi-finished product used for the production of the respective component can be cut to a contour. This contour is chosen in such a way that the forming process creates a contour of the edge area of the bulkhead specific to the type of motor vehicle to be manufactured.

The approach makes it possible to implement a platform strategy in which the bulkheads produced for the vehicle bodies of different vehicle types can be easily adapted during the ongoing process. In particular, it is only necessary to adjust the contour to which the edge area of the semi-finished product used is cut to use the component in the respective type of motor vehicle. For example, different widths of the semi-finished product can be used to create bulkheads of different widths. In this context, an orientation of the edge areas of the bulkhead, which runs at least essentially in the transverse direction of the motor vehicle, is advantageous, since the specification of the contour of the formed component by cutting the edge area of the semi-finished product to size can create bulkheads of different widths. In this way, it is possible to elegantly implement a platform strategy in the production of different types of motor vehicles with regard to the production of the bulkhead.

Alternatively and/or after the forming process has been carried out, the edge area of the respective component can be cut to a contour of the bulkhead specific to the type of motor vehicle to be manufactured. This can be done both on the basis of the components described above, which are manufactured by means of the forming process, which may be identical for the different vehicles before the edge area is cut to size, in particular with regard to their contours, and on the basis of components in the manufacture of which the contour of the semi-finished product used has already been cut to size.

Preferably, laser cutting processes, in particular laser remote cutting, can be used for cutting the contour to size. In this context, remote laser cutting for cutting the edge area is particularly advantageous, as the high flexibility in the beam guidance of the laser beam allows for a great degree of freedom with regard to changing the cutting process to be carried out from component to component.

In particular, the forming process can be carried out using an identical tool for different types of motor vehicles. While the trimming of the edges, in particular by means of the laser cutting methods described above, can be easily adapted to different types of motor vehicles, considerable investment costs for a forming tool, especially a hot forming tool, are incurred. In addition, the change of a forming tool and thus the modification of a corresponding forming device is comparatively more complex than the adaptation of a cutting process, especially a laser cutting process, in which, in the best case, only a control intervention is necessary to adjust the contour to be generated.

Alternatively and/or in addition, the method may provide for the use of a type of semi-finished product specific to the type of motor vehicle to be manufactured, depending on the type of motor vehicle to be manufactured. The forming of the different types of semi-finished products is preferably carried out in an identical forming tool. The types of semi-finished products may differ from each other, in particular in the thickness of the semi-finished products and/or the thickness of individual areas of the semi-finished products. In particular, this allows for weight-optimized bulkheads for the different types of motor vehicles to be produced in an economically sensible way.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a schematic horizontal sectional representation of the course of the bulkhead,

FIG. 2 shows a schematic representation of the connection of the structural elements with the bulkhead,

FIG. 3 shows a schematic representation of the connection of the longitudinal beams, the structural components and the cowl crossmember to the bulkhead,

FIG. 4 shows connecting the pre-assembled front end structure with the body area located behind the bulkhead,

FIG. 5 shows the state after connecting the body area behind the bulkhead to the pre-assembled front end structure, and

FIG. 6 shows the exemplary vehicle body after further assembly steps.

### DETAILED DESCRIPTION

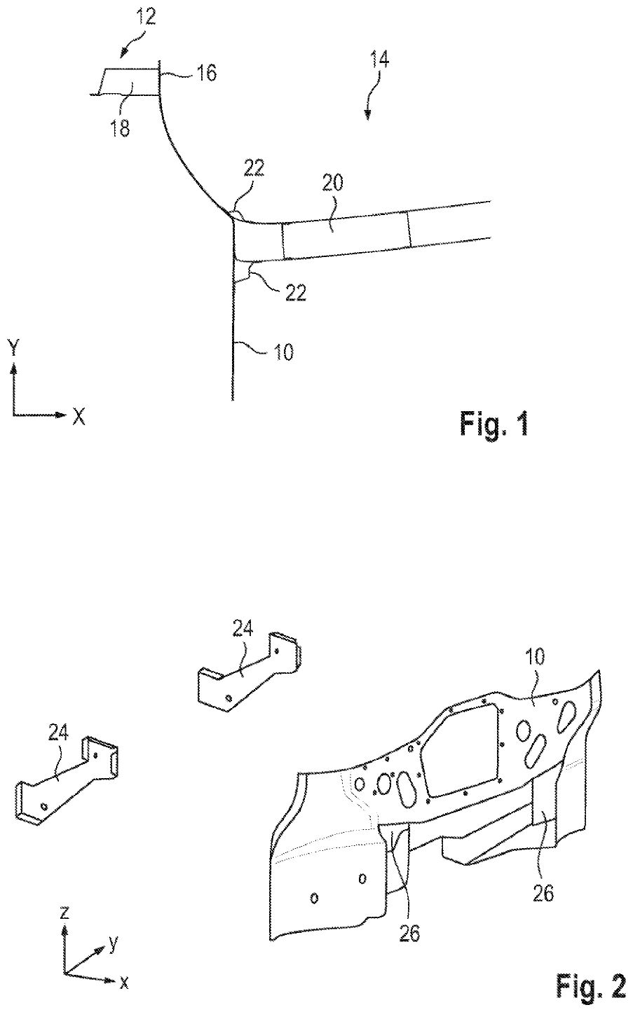

FIG. 1 illustrates how the bulkhead 10 forms a separation between the body area 12 located behind the bulkhead 10 and the pre-assembled front end structure 14. In this case, an edge area 16 of the bulkhead 10 can be oriented essentially in the transverse direction of the vehicle Y and can be supported in a side panel structure 18 of the body arranged in the longitudinal direction of the vehicle X behind the bulkhead 10. The side panel structure 18 may, as in the example shown, form part of an A-pillar extending from the lower part of the vehicle body, in particular the floor of the vehicle body, to the roof of the vehicle body.

As shown as an example, the bulkhead 10 can be formed from a component that is produced from a two-dimensional semi-finished product by means of a forming process. In this case, it is advantageous if the formed component extends [sic] at least over both sides of the motor vehicle across the wheel arches and/or edge areas 16 of the bulkhead 10, as shown by way of example.

The longitudinal beams 20 can be connected to the bulkhead 10 by means of connecting elements 22, as shown in the example.

As shown by way of example in FIG. 2, in the context of the method of assembling a vehicle body, structural elements 24 can first be passed through openings 26 in the bulkhead 10. As an alternative or in addition to this, the structural elements 24 can be connected to the bulkhead 10, thus forming a composite of bulkhead 10 and structural elements 24.

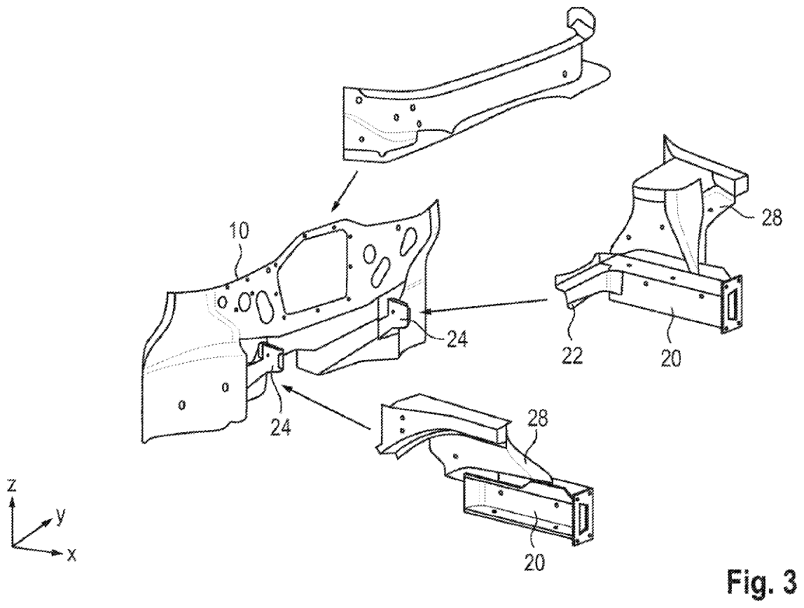

FIG. 3 shows how the composite of bulkhead 10 and structural elements 24 can be connected to other components of the front end. In the example shown, the bulkhead 10 thus becomes part of the pre-assembled front end structure 14. In the example shown, the separation between the pre-assembled front end structure 14 and the body area 12 runs directly behind the bulkhead 10.

As shown in the example shown, the longitudinal beams 20 can first be connected to the connecting elements 22 to connect the longitudinal beams 20 to the bulkhead 10. Other structural components 28, which can include a strut dome and part of a wheel arch, as in the example shown, can also be connected to the respective longitudinal beams 20. The units formed in this way can then be connected to the composite formed by the bulkhead 10 and the structural elements 24. As in the example shown, a cowl crossmember 30 can also be connected to the composite of the bulkhead 10 and the structural elements 24.

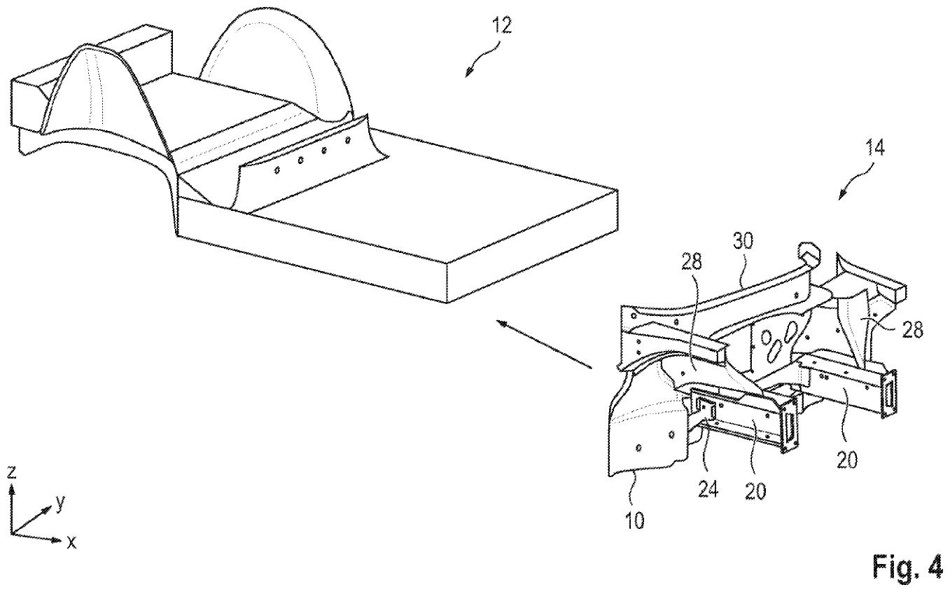

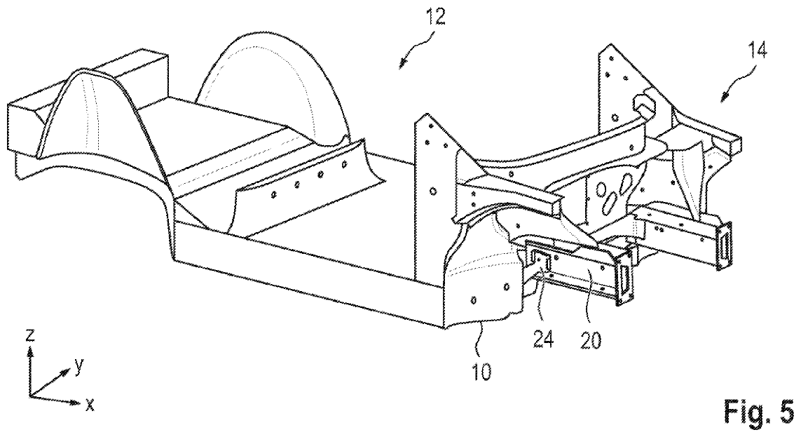

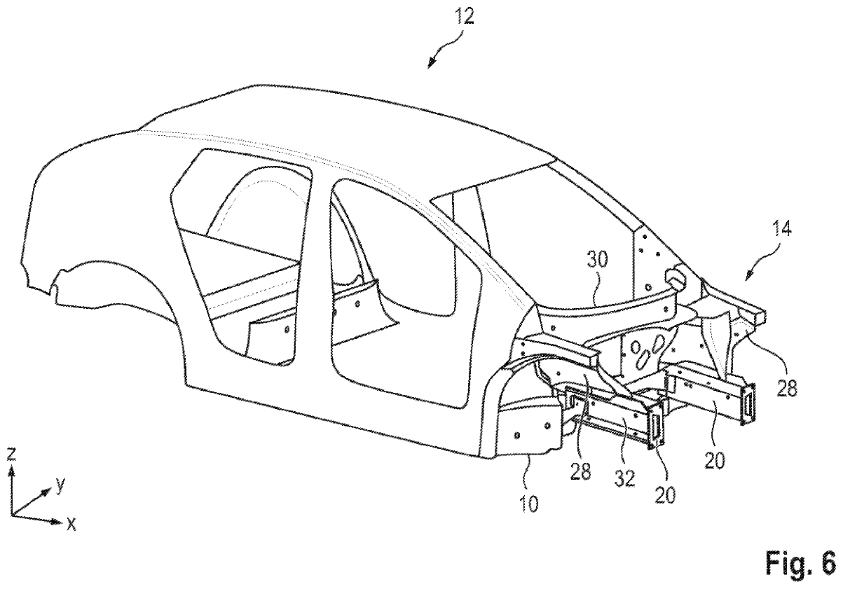

As can be seen in particular from FIGS. 4 and 5, the connection of the structural elements 24 with the longitudinal beams 20 can be carried out in such a way that the structural elements 24 are connected to the inner side of the longitudinal beams 20, which are designed as hollow structures. This can be made possible by attaching a section 32 of the respective longitudinal beam 20 to the longitudinal beam 20 only after the corresponding structural element has been connected to the inner side of the longitudinal beam 20. In the example shown, this is the case between the times of the assembly of the vehicle body shown in FIG. 5 and FIG. 6.

As can be seen from FIGS. 4 to 6, the body area 12, which is located behind the bulkhead 10, can be pre-assembled, at least in part, before it is connected to the front end structure 14 and, as shown in FIGS. 5 and 6, after the front end structure 14 has been connected to the body area 12 located behind the front bulkhead 10, a further assembly of the body area 12 can take place.

The features of the invention disclosed in the present description, drawings and claims may be essential to the realization of the invention in its various embodiments, either individually or in any combination. The invention can be varied within the scope of the claims and taking into account the knowledge of the competent skilled person.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for assembling a motor vehicle body, the motor vehicle body comprising a front end structure with a bulkhead and a body area arranged in a longitudinal direction of the motor vehicle behind the bulkhead;
pre-assembling the front end structure separately from the body area before the front end structure is connected to the body area located behind the bulkhead;
providing a separation between the pre-assembled front end structure and the body area, the separation being formed immediately in front of or behind the bulkhead.

2. The method according to claim 1, wherein, during the pre-assembly of the front end structure, longitudinal beams of the front end structure are connected with the bulkhead.

3. The method according to claim 1, wherein the connection of the longitudinal beams with the bulkhead is made via connecting elements which are connected to both the bulkhead and the long beams.

4. The method according to claim 3, wherein the connecting elements and the areas of the bulkhead connected to the connecting elements are made of steel and the longitudinal beams are first connected to the connecting elements before connecting them to the bulkhead.

5. The method according to claim 1, wherein during pre-assembly, structural elements for connecting the longitudinal beams are connected to the body area located behind the bulkhead with the longitudinal beams.

6. The method according to claim 5, wherein the longitudinal beams are designed as a hollow structure, wherein the structural elements are connected to the inner side of the hollow structure and a section of the respective longitudinal beam is connected to the longitudinal beam only after the connection of the corresponding structural element to the inner side of the longitudinal beam.

7. The method according to claim 5, wherein the structural elements must first be connected to the bulkhead or wherein the structural elements are guided through openings in the bulkhead before the longitudinal beams are connected to the bulkhead and/or the structural elements with the longitudinal beams.

8. The method according to claim 1, wherein structural components comprising at least a section of an upper longitudinal beam, a strut dome and/or a wheel arch are first connected to the longitudinal beams before the longitudinal beams are connected to the structural elements and/or the bulkhead.

9. The method according to claim 1, wherein a cowl crossmember is connected to the bulkhead and/or the structural components before connecting the front end structure to the body area located behind the bulkhead.

10. The method according to claim 1, wherein a component forming at least the section of the bulkhead, which is connected to the longitudinal beams, is manufactured via a forming process from a two-dimensional semi-finished product.
